(19) United States
(12) Patent Application Publication
(10) Pub. No.: US 2006/0158304 A1
(43) Pub. Date: Jul. 20, 2006

(54) Resistive material, resistive element, resistor, and method for manufacturing resistor

(76) Inventor: Satoshi Moriya, Nagano (JP)

Correspondence Address: SMITH PATENT OFFICE, 1901 PENNSYLVANIA AVENUE N W, SUITE 901, WASHINGTON, DC, 20006, US

(21) Appl. No.: 10/538,744

(22) PCT Filed: Dec. 15, 2003
(86) PCT No.: PCT/JP03/16013

§ 371 Date: Mar. 20, 2006

(30) Foreign Application Priority Data
Dec. 16, 2002 (JP) 2002-363363

(51) Int. Cl. H01C 7/10

(52) U.S. Cl. 338/22 R

(57) ABSTRACT

A resistive material containing metallic powder including copper, manganese, and aluminum, glass powder and/ or copper oxide powder, and a vehicle is provided. The metallic powder is made by mixing 80 to 85 weight percent copper, 8 to 16 weight percent manganese, and 2 to 7 weight percent aluminum. A maximum of 10 weight percent glass powder and/ or copper oxide powder and 10 to 15 weight percent vehicle relative to the entire 100 weight percent metal mixed powder are added. The resulting resistive material is then wintered in an inactive atmosphere, thereby providing a resistor and a resistive element having target characteristics such as a low resistance, a low TCR value, and a low thermo-electromotive force.

### BACKGROUND OF THE INVENTION

1. Field of the Invention

The present invention relates to a resistive material to be used as a material of a resistive element of a chip resistor, a resistive element, a resistor using the resistive material, and a method for manufacturing the same. The present invention is effective especially when it is applied to a current detecting resistor used in current detecting circuits.

2. Description of the Related Art

Current detecting resistors are utilized in electronic circuits or power supply circuits in a variety of electronic devices. Low resistance and low temperature coefficient of resistance (TCR) have been desired as characteristics of such current detecting resistors.

The following technology which allows provision of the aforementioned characteristics has been disclosed in Laid-open Japanese Patent Application No. 10-144501. Namely, as shown in FIG. 5, conventional chip resistors are fabricated by printing a resistive material made of copper (Cu)-nickel (Ni) alloy components on a surface of an insulating substrate 100 so that a resistive material 103 is formed, and then forming upper electrodes 102 so as to make surface contact with that resistive material 103, sintering the resistive element 103 and the upper electrodes 102, and then forming a protective layer 104, which protects the resistive element 103, edge electrodes 105, nickel plated layers 106, and solder plated layers 107. With such a structure, since there are no impurities at the joint interface between the resistive element 103 and the upper electrodes 102, low resistance and low temperature coefficient of resistance (TCR) are provided by utilizing the copper-nickel alloy material characteristics.

Copper electrodes of a resistor having a resistive element containing copper and nickel as main components, which is formed through thick-film printing, such as screen printing, the resistive element such as a paste resistive material particularly may cause a current detection error due to influences of thermo-electromotive force. Note that the thermo-electromotive force generated by copper-nickel material relative to copper is 46 μV/K.

A principal objective of the present invention is to create resistive materials that can replace copper-nickel material. In addition, the present invention is to provide resistive elements, a resistor using the resistive elements, and a method for manufacturing the resistor.

### SUMMARY OF THE INVENTION

To achieve the aforementioned objectives, a resistive material, according to the present invention, contains metallic powder including copper, manganese, and aluminum, glass powder and/ or copper oxide powder, and a vehicle. It is preferable that the metallic powder includes 80 to 85 weight percent copper, 8 to 16 weight percent manganese, and 2 to 7 weight percent aluminum.

It is also preferable that a maximum of 10 weight percent of the glass powder and/or the copper oxide powder, and 10 to 15 weight percent of the vehicle relative to the 100 weight percent metallic powder are added.

The metallic powder is made by mixing copper, manganese, and aluminum as follows. In other words, according to a first composition, copper powder, manganese powder, and aluminum powder are mixed. According to a second composition, copper-manganese alloy powder and aluminum powder are mixed. According to a third composition, copper-aluminum alloy powder and manganese powder are mixed. According to a fourth composition, manganese-aluminum alloy powder and copper powder are mixed. According to a fifth composition, copper-manganese-aluminum alloy powder is used.

A resistive element according to the present invention includes copper, manganese, and aluminum. It is preferable that the resistive element includes 80 to 85 weight percent copper, 8 to 16 weight percent manganese, and 2 to 7 weight percent aluminum.

In addition, a resistor according to the present invention includes an insulating substrate; a resistive element including copper, manganese, and aluminum formed on the insulating substrate; and a pair of electrodes connected to the resistive element.

Conductive components contained in the resistive element are characterized by 80 to 85 weight percent copper, 8 to 16 weight percent manganese, and 2 to 7 weight percent aluminum.

In addition, an aspect of the present invention is characterized by copper used for the electrodes of the resistor.

An aspect of the present invention is characterized by temperature coefficient of resistance of the resistor being between positive and negative 100×10⁻⁶/K. An aspect of the present invention is characterized by thermo-electromotive force of the resistive element being between positive and negative 5 μV/K.

A resistor manufacturing method according to the present invention includes the steps of printing a resistive material including copper, manganese, and aluminum onto an insulating substrate, and sintering the resistive material in a nitrogen atmosphere, thereby providing a resistive element. The resistor manufacturing method further includes the steps of printing a conductive material containing copper as a main component onto the insulating substrate, and sintering the conductive material in a nitrogen atmosphere, thereby providing electrodes.

### BRIEF DESCRIPTION OF THE DRAWINGS

FIG. 1 is a flowchart showing a resistive material manufacturing process according to an embodiment of the present invention;

FIG. 2 is a diagram showing a preferred composition range, according to the embodiment of the present invention;

FIG. 3 is a diagram showing a cross-section of a chip resistor according to an embodiment of the present invention;

FIG. 4 is a flowchart showing a chip resistor manufacturing process; and

FIG. 5 is a diagram showing a cross-section of a conventional chip resistor.

### DESCRIPTION OF THE PREFERRED EMBODIMENTS

An embodiment of the present invention is described forthwith while referencing accompanied drawings and a table.

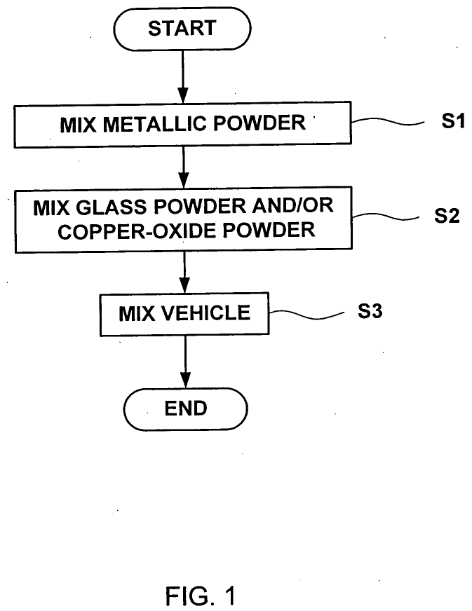

FIG. 1 shows a resistive material manufacturing process according to an embodiment of the present invention. In step S1 of FIG. 1, metallic powder, which is a main component of a resistive material, is mixed. In this step, powders made of 85 weight percent copper (Cu), 9.5 weight percent manganese (Mn), and 5.5 weight percent aluminum (Al), respectively, are measured and then mixed together into metallic powder. The average particle diameters of copper powder, manganese powder, and aluminum powder are: 1.1 μm, 10 μm, and 10 μm, respectively. Note that it is preferable that an allowable range of the particle diameter of each powder is between 0.1 μm and 20 μm for screen printing.

In step S2, glass powder and/or copper oxide powder is added to the metallic powder made in step S1. 0.5 parts glass powder by weight and 5 parts copper oxide powder by weight relative to the entire amount of 100 parts metallic powder by weight as described above are added. Borosilicate zinc glass is used as glass powder. Copper monoxide (Cu₂O) is used as copper oxide powder.

Addition of glass powder aims to physically adhere the resistive element with an alumina substrate to be described later. It is preferable that the ratio of glass powder to be added does not exceed a maximum of 10 parts by weight relative to 100 parts metallic powder by weight described above. This is because the resistivity of the resistive material increases.

It is also preferable in light of workability that the aforementioned glass powder is made of water-proof elements having acid resistance and a softening point of 500 to 1000 degrees Centigrade. Accordingly, it may be made of borosilicate glass, more specifically, borosilicate barium glass, borosilicate calcium glass, borosilicate barium calcium glass, borosilicate zinc glass, zinc borate glass or the like. Note that it is preferable that the particle diameter of glass powder is in an allowable range for screen printing, for example, between 0.1 μm and 20 μm. In this embodiment, powder with an average particle diameter of 2 μm is used.

Addition of copper oxide powder aims to chemically adhere the resistive element with an alumina substrate to be described later. It is preferable that the ratio of the copper oxide powder does not exceed a maximum of 10 parts by weight relative to 100 parts metallic powder by weight described above. This is because if it exceeds 10 parts by weight, the resistive element becomes porous, and the smoothness of the resistive element is impaired. Either of copper oxide (CuO) or copper monoxide (CU₂O) may be used as copper oxide powder. In addition, it is preferable that the particle diameter of copper oxide powder is within an allowable range for screen printing, for example, between 0.1 μm and 20 μm. In this embodiment, powder with an average particle diameter of 2 μm is used.

Note that it is preferable that at least either glass powder or copper oxide powder is added to the resistive material so as to adhere the resistive element with an alumina substrate. In addition, when adding both glass powder and copper oxide powder, it is preferable that the total amount of additives of the glass powder and copper oxide powder is 10 parts by weight relative to 100 parts metallic powder by weight as described above. In this case, it is preferable that both glass powder and copper oxide powder are added in the same ratio with consideration of influences on the characteristics of the completed resistor.

In step S3, a vehicle is added. 12 parts vehicle by weight is added to the entire 100 parts mixed powder by weight made from the aforementioned metallic powder, glass powder, and copper oxide powder. Texanol solution containing 2.5 weight percent ethyl cellulose is used as the vehicle.

The vehicle is added so as to make the metallic powder be paste, which facilitates printing onto an insulating substrate. It is preferable that the amount of vehicle to be added is 10 to 15 parts by weight relative to 100 parts powder by weight made from the aforementioned metal material and glass powder and/or copper oxide powder. This amount provides suitable viscosity for maintaining an accurate printed form when printing a resistive material onto an alumina substrate through screen printing.

The vehicle is made from resin and solvent; wherein cellulosic resin, acrylic resin, or alkyd resin may be used independently or in combination as the resin. More specifically, ethyl cellulose, ethyl acrylate, butyl acrylate, ethyl methacrylate, and butyl methacrylate, or the like are available.

In addition, a terpene based solvent, an ester alcohol based solvent, an aromatic hydrocarbon based solvent, or the like may be used independently, or in combination as the solvent. More specifically, it may be terpineol, dihydroterpineol, 2,2,4-trimethyl-1,3-pentanediol, texanol, xylene, isopropylbenzene, toluene, acetic acid diethylene glycol monomethyl ether, acetic acid diethylene glycol monobutyl ether or the like.

Note that various additives other than the above may be added to the resistive material. For example, a flocculating inhibitor, an anti-forming agent or the like may be added as an additive.

The material made in steps S1 through S3 is kneaded using a 3-roll mill, resulting in a resistive material.

Next, the characteristics of the resistive material according to an embodiment of the present invention are measured as follows. An alumina substrate made of 96 weight percent alumina is first prepared. A plurality of electrodes is formed through screen printing, and sintering a conductive material containing copper as a main component on the alumina substrate. The aforementioned resistive material is printed through screen printing so as to extend over the electrodes. The resistive element is then made by sintering in a nitrogen (N₂) atmosphere for ten minutes at 900 degrees Centigrade. Note that the dimensions of the resistive element are 1 mm×52 mm in order to prevent the TCR of the copper electrode from affecting the characteristics of the resistive element. The film thickness of a resistive element after sintered is measured as 20.3 μm.

Regarding the respective resulting resistive elements, the resistances thereof are measured at 25 degrees Centigrade and 125 degrees Centigrade, respectively. Restistivity and TCR are then calculated. As a result, the resistivity is 1.49 μΩm, and the TCR is 80×10⁻⁶/K, for example. In addition, the thermo-electromotive force is 1 μV/K.

TABLE 1

| | | | | | | | Thermo- |
|---|---|---|---|---|---|---|---|
| | | | | | | | Electromotive |
| Sample | Cu | Mn | Al | Ni | Resistivity | TCR | Force vs Copper |
| No. | [wt %] | [wt %] | [wt %] | [wt %] | [μΩm] | [×10⁻⁶/K] | [μV/K] |
| 1 | 80.0 | 20.0 | — | — | 2.03 | 10 | 12 |
| 2 | 90.0 | 10.0 | — | — | 0.63 | 260 | 5 |
| 3 | 82.0 | 16.0 | 2.0 | — | 1.86 | 45 | 4 |
| 4 | 86.0 | 12.0 | 2.0 | — | 1.42 | 128 | 3 |
| 5 | 90.0 | 8.0 | 2.0 | — | 0.50 | 351 | 3 |
| 6 | 84.0 | 13.0 | 3.0 | — | 1.66 | 76 | 1 |
| 7 | 82.0 | 14.0 | 4.0 | — | 1.83 | 44 | 1 |
| 8 | 85.0 | 9.5 | 5.5 | — | 1.49 | 80 | 1 |
| 9 | 88.0 | 6.0 | 6.0 | — | 1.00 | 288 | −2 |
| 10 | 82.0 | 12.0 | 6.0 | — | 1.83 | 45 | 1 |
| 11 | 80.0 | 13.0 | 7.0 | — | 1.89 | 39 | −1 |
| 12 | 82.0 | 10.0 | 8.0 | — | 1.69 | 136 | 2 |
| 13 | 85.0 | 8.0 | 7.0 | — | 1.42 | 94 | −3 |
| 14 | 80.0 | 6.0 | 14.0 | — | 1.62 | 151 | 7 |
| Comparative | 40.0 | — | — | 60.0 | 1.86 | 86 | 46 |
| Example | | | | | | | |

Table 1 shows characteristics of samples 1 through 14 made of a variety of metallic powders, respectively, and a comparative example. The embodiment described above corresponds to sample 8. In addition, as is described later, samples 1 through 14 include an example not falling within the range of the present invention. Samples 1 through 14 are examples made from respective metallic powders, each made from copper, manganese, and aluminum according to a compound ratio given in Table 1. The comparative example shown in Table 1 uses metallic powder made from 40 weight percent copper and 60 weight percent nickel. In addition, the resistive elements of the respective samples given in Table 1 are alloyed forms of the contained metallic powder resulting from sintering the respective resistive materials.

Regarding the respective samples and the comparative example, the resistances of the respective resistive elements are measured at 25 degrees Centigrade and 125 degrees Centigrade, respectively, in the same manner as described above. Resistivity (μΩm), TCR, and thermo-electromotive force (μV/K) are then calculated.

Sample 1 in Table 1 is a resistive element made from resistive materials of copper and manganese constituting metallic powder. Even with such a composition, the thermo-electromotive force is 12 μV/K, which is lower than 46 μV/K of the aforementioned copper-nickel resistive material (shown in the comparative example). However, since the resistivity is 2.03 μm, which is high, establishment of low resistance is difficult.

The resistivity of sample 2 decreases to be 0.63 μΩm, which is because sample 2 contains more amount of copper than sample 1. However, the TCR is 260×10⁻⁶/K, which is higher than that of the comparative example. As such, it is difficult to control the characteristics of the copper-manganese resistive element since either one of the resistivity or the TCR is favorable, and the other is unfavorable depending on the copper content. Therefore, according to the present invention, it is determined that copper-manganese-aluminum resistive elements illustrated as samples 3 through 14 are favorable.

Further suitable conditions for the copper-manganese-aluminum samples are described below. As desirable characteristics of resistive elements, it is preferable that the thermo-electromotive force is as small as possible, more preferably, it falls between ±5 μV/K, and the TCR falls between ±100×10⁻⁶/K. These requirements are criteria for selecting favorable examples according to the present invention.

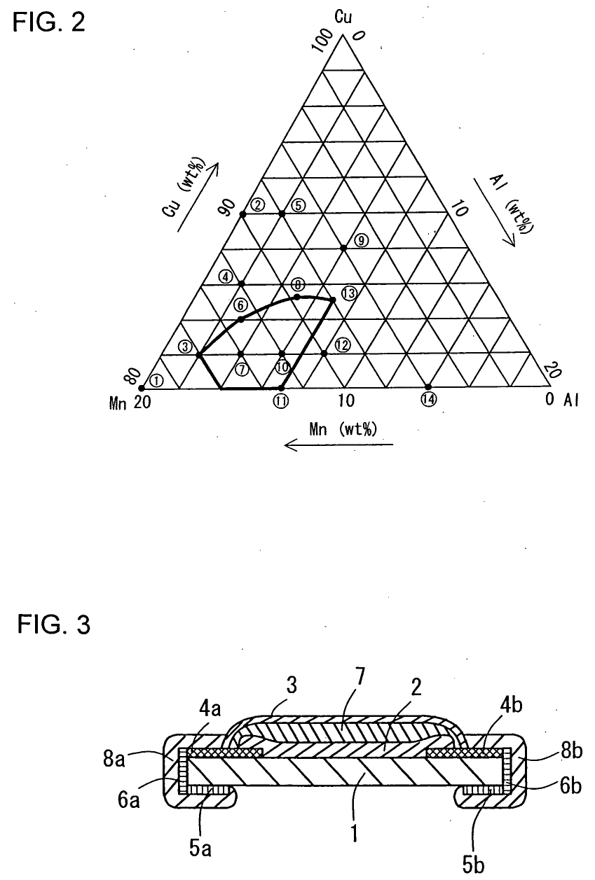

The results of analyzing the samples in Table 1 are given below. FIG. 2 is a composition diagram showing plotted copper-manganese-aluminum compound ratios for the respective samples. In the drawing, numbers in circles (O) correspond to the respective samples 1 through 14 given in Table 1. In addition, compounding ratios enclosed by a bold line are favorable according to the present invention.

Preferred samples according to the present invention are samples 3, 6, 7, 8, 10, 11, 12, and 13.

As a result, preferred metallic powder compositions according to the present invention are 80 to 85 weight percent copper, 8 to 16 weight percent manganese, and 2 to 7 weight percent aluminum.

Some methods of making metallic powder are described below. According to a first method, metallic powder is made by mixing independent copper powder, manganese powder, and aluminum powder as described above. According to a second method, metallic powder is made by mixing copper-manganese alloy powder and aluminum powder. According to a third method, metallic powder is made by mixing copper-aluminum alloy powder and manganese powder. According to a fourth method, metallic powder is made by mixing manganese-aluminum alloy powder and copper powder. According to a fifth method, copper-manganese-aluminum alloy powder is used.

Metallic powder compositions: 80 to 85 weight percent copper, 8 to 16 weight percent manganese, and 2 to 7 weight percent aluminum according to the first to the fifth methods fall within the scope of the present invention. Note that use of pre-alloyed powder contributes to suppression of variations in the characteristics of resistive elements. From those views, the fifth method is the most preferable, and subsequently the second through the fourth methods are preferable. Note that according to the embodiment of the present invention, each sample is made using the first method for convenience of making samples.

FIG. 3 shows a cross-section of an exemplary chip resistor using a resistive material according to the present invention. In FIG. 3, a substrate 1 is an electrically insulating ceramic substrate. For example, an alumina substrate, a forsterite substrate, a mullite substrate, an aluminum nitride substrate, or a glass ceramic substrate may be used as a material of the substrate 1.

A resistive element 2 is formed upon the substrate 1. The resistive element 2 is made by coating the resistive material according to the present invention through screen printing, and then sintering it. On both ends of the resistive element 2 are formed upper electrodes 4a and 4b, which have electrical contact therewith.

Lower electrodes 5a and 5b are formed at the ends of the substrate 1 bottom. The resistive element 2 is coated with a pre glass 7. The pre glass 7 is coated with a protective layer 3. In addition, end electrodes 6a and 6b, which electrically connect the upper electrodes 4a and 4b and the lower electrodes 5a and 5b, respectively, are formed on both sides of the substrate 1.

An external electrode 8a is formed so as to cover the exposed portion of the upper electrode 4a, the lower electrode 5a, and the end electrode 6a. Similarly, an external electrode 8b is formed so as to cover the exposed portion of the upper electrode 4b, the lower electrode 5b, and the end electrode 6b. These external electrodes 8a and 8b are made through plating.

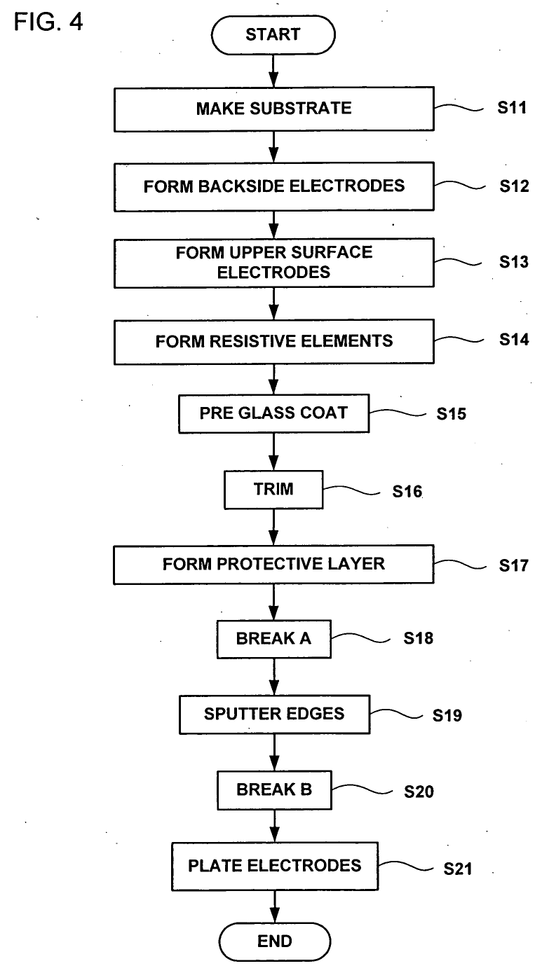

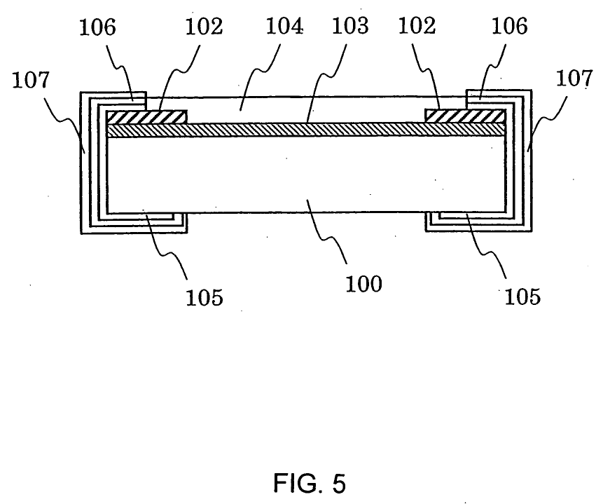

FIG. 4 is a flowchart showing an exemplary manufacturing method for chip resistors according to the present invention. In step S11 of FIG. 4, an alumina substrate is prepared for constituting the completed substrate 1. The alumina substrate is made of 96 weight percent alumina. A large alumina substrate is used for fabricating a great number of chip resistors at once, and is divided into multiple chips in a subsequent process.

In step S12, the lower electrodes 5a and 5b are formed at the bottom of the alumina substrate. More specifically, the lower electrodes 5a and 5b are formed by screen printing a predetermined pattern of a conductive material containing copper as a main component, and then sintering it in a nitrogen (N₂) atmosphere for ten minutes at 900 to 1000 degrees Centigrade.

In step S13, the upper electrodes 4a and 4b are formed upon the upper surface of the alumina substrate. More specifically, the upper electrodes 4a and 4b are formed by screen printing a predetermined pattern of a conductive material containing copper as a main component, and then sintering it in a nitrogen (N₂) atmosphere for ten minutes at 900 to 1000 degrees Centigrade. Note that the upper electrodes 4a and 4b and the lower electrodes 5a and 5b may be sintered simultaneously.

Silver (Ag) or copper may be used as a conductive material of the electrodes. In the case of electrodes made of silver, particular chip resistor usage conditions may cause electronic migration to develop, thereby bringing about degradation in performance such as current detection capability. In order to solve such problem, according to the embodiment, a conductive material containing copper as a main component is used for the upper electrodes 4a and 4b, and the lower electrodes 5a and 5b. In addition, according to the embodiment, the upper electrodes 4a and 4b, and the lower electrodes 5a and 5b are sintered in a nitrogen (N₂) atmosphere or an inactive atmosphere so that oxidation of copper can be prevented.

In step S14, the resistive element 2 is formed. More specifically, the resistive element 2 is formed through screen printing a predetermined pattern of a resistive material according to the present invention so as to connect the upper electrodes 4a and 4b, and then sintering it in a nitrogen (N₂) atmosphere for ten minutes at 900 to 1000 degrees Centigrade. Sintering in a nitrogen (N₂) atmosphere or an inactive atmosphere aims to prevent oxidation of the resistive material.

Copper, manganese, and aluminum contained in the resistive material are sintered into an alloy.

The major conductive components contained in the sintered resistive element 2 are 80 to 85 weight percent copper, 8 to 16 weight percent manganese, and 2 to 7 weight percent aluminum. Addition of copper oxide to the resistive material according to the present invention allows favorable adhesion between the substrate 1 and the resistive element 2. A glass powder allows provision of sufficient intensity of an inorganic binder film or resistive element 2. In addition, the vehicle containing an organic binder or resin contributes to provision of a highly accurate printed pattern.

In step S15, the pre glass 7 for coating the resistive element 2 is formed. More specifically, the pre glass 7 is formed by screen printing borosilicate zinc based glass paste so as to cover the resistive element layer 2 and then sintering in a nitrogen (N₂) atmosphere for ten minutes at 600 to 700 degrees Centigrade. Alternatively, other than borosilicate zinc based glass, borosilicate barium based glass, borosilicate calcium based glass, borosilicate barium calcium based glass, or zinc borate based glass may be used.

In step S16, resistance adjustment (trimming) is carried out. More specifically, resistance adjustment is carried out by irradiating the resistive element 2 with a laser beam from the pre glass 7 so as to slit it.

In step S17, the protective layer 3,which is used as an insulating layer, is formed by screen printing epoxy resin so as to cover the surface of the pre glass 7 and part of the upper electrodes 4a and 4b and then hardening it. Afterwards, a type number, a resistance value, and the like are then displayed upon the protective layer 3 as needed, using colored epoxy resin or the like.

In step S18, the alumina substrate is divided (break A). In this step, the alumina substrate is divided into strips. This break A exposes sides of the alumina substrate sandwiched between the upper electrode 4a and the lower electrode 5a, and between the upper electrode 4b and the lower electrode 5b.

In step S19, the end electrodes 6a and 6b for connecting the upper electrode 4a and the lower electrode 5a, and the upper electrode 4b and the lower electrode 5b, respectively, are formed by forming NiCr alloy layers on the sides of the strip alumina substrate through sputtering. NiCrCu, CuTi, Ni, Ag, Au, or the like may be used as a material for sputtering. Note that the end electrodes 6a and 6b may be formed through deposition, immersion, or coating.

In step S20, the alumina substrate divided into strips is further divided into chips (break B). In this embodiment, dimensions of the obtained chips are 3.2 mm×1.6 mm.

In step S21, the external electrodes 8a and 8b are formed upon the exposed portion of the upper electrodes 4a and 4b that is not covered by the protective layer 3, the lower electrodes 5a and 5b, and the end electrodes 6a and 6b. The external electrodes 8a and 8b are then subjected to electrolytic nickel plating, electrolytic copper plating, electrolytic nickel plating, and electrolytic tin plating in this order, thereby becoming a nickel—copper—nickel—Sn layered structure.

The 3.2 mm×1.6 mm chip resistor fabricated in the manner as described above measures 470 μm in substrate thickness, 20 μm in upper side electrode thickness, 20 μm in lower side electrode thickness, 30 to 40 μm in resistive layer thickness, 10 μm in pre coating glass thickness, 30 μm in protective layer thickness, and 0.05 μm in end electrode thickness. Regarding the external electrode thickness, the Ni layer measures 3 to 7 μm in thickness, the Cu layer measures 20 to 30 μm in thickness, the Ni layer measures 3 to 12 μm in thickness, and the Sn layer measures 3 to 12 μm in thickness.

When using a resistive material according to the present invention, it is preferable that sintering the resistive element and subsequent sintering are carried out in a neutral atmosphere or an inactive atmosphere (e.g., a nitrogen (N₂) atmosphere). Resistive materials, resistive elements, and resistors having low resistance, low TCR, and low thermo-electromotive force may be manufactured using the aforementioned processes.

### INDUSTRIAL APPLICABILITY

As described above, use of the resistive material according to the present invention allows provision of a resistive element having a lower resistivity than that of a copper-nickel resistive element, a low TCR value (between ±100×10⁻⁶/K), and a much lower thermo-electromotive force.

In addition, use of the resistive material according to the present invention allows fabrication of highly accurate chip resistors having a low resistance value of 50 mΩ to 100 mΩ, a low resistivity, a low TCR value, and a low thermo-electromotive force. These chip resistors are optimal for applications such as a current detection resistor for power supply circuits or motor circuits.

1. A resistive material, comprising:
metallic powder containing copper, manganese, and aluminum;
glass powder and/or copper oxide powder; and
a vehicle.

2. The resistive material according to claim 1, wherein said metallic powder comprises 80 to 85 weight percent copper, 8 to 16 weight percent manganese, and 2 to 7 weight percent aluminum.

3. The resistive material according to claim 2, wherein a maximum of 10 parts by weight of said glass powder and/or said copper oxide powder is included in the resistive material.

4. The resistive material according to claim 3, wherein 10 to 15 parts by weight of said vehicle is included in the resistive material.

5. The resistive material according to claim 4, wherein said metallic powder is made by mixing copper powder, manganese powder, and aluminum powder.

6. The resistive material according to claim 4, wherein said metallic powder is made of a copper-manganese-aluminum alloy powder.

7. The resistive material according to claim 4, wherein said metallic powder is made by mixing copper-manganese alloy powder and aluminum powder.

8. The resistive material according to claim 4, wherein said metallic powder is made by mixing copper-aluminum alloy powder and manganese powder.

9. The resistive material according to claim 4, wherein said metallic powder is made by mixing manganese-aluminum alloy powder and copper powder.

10. A resistive element, including copper, manganese, and aluminum.

11. The resistive element according to claim 10, wherein said resistive element comprises 80 to 85 weight percent copper, 8 to 16 weight percent manganese, and 2 to 7 weight percent aluminum.

12. A resistor, comprising:
an insulating substrate;
a resistive element containing copper, manganese, and aluminum formed on said insulating substrate; and
a pair of electrodes connected to said resistive element.

13. The resistor according to claim 12, wherein a conductive component contained in said resistive element comprises 80 to 85 weight percent copper, 8 to 16 weight percent manganese, and 2 to 7 weight percent aluminum.

14. The resistor according to claim 12, wherein copper is used for said electrodes.

15. The resistor according to claim 13, wherein temperature coefficient of resistance is between −100×10⁻⁶/K and 100×10⁻⁶/K.

16. The resistor according to claim 13, wherein thermo-electromotive force is between −5 μV/K and 5 μV/K.

17. A resistor manufacturing method, comprising the steps of:
printing a resistive material containing copper, manganese, and aluminum onto an insulating substrate; and
sintering said resistive material in a nitrogen atmosphere, thereby providing a resistive element.

18. The resistor manufacturing method according to claim 17, further comprising the steps of:
printing a conductive material containing copper as a main component onto said insulating substrate; and
sintering said conductive material in a nitrogen atmosphere, thereby providing electrodes.
